(19) United States
(12) Patent Application Publication
(10) Pub. No.: US 2013/0042185 A1
(43) Pub. Date: Feb. 14, 2013

(54) ELECTRONIC DEVICE AND COMMUNICATION MANAGEMENT METHOD THEREOF

(71) Applicants: HAN-CHE WANG, Tu-Cheng (TW); KUAN-HONG HSIEH, Tu-Cheng (TW); XIAO-GUANG LI, Shenzhen City (CN)

(72) Inventors: HAN-CHE WANG, Tu-Cheng (TW); KUAN-HONG HSIEH, Tu-Cheng (TW); XIAO-GUANG LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/483,067

(22) Filed: May 30, 2012

(30) Foreign Application Priority Data
Aug. 9, 2011 (CN) 201110226921.6

(51) Int. Cl. G06F 3/01; G06F 15/16

(52) U.S. Cl. 715/752

(57) ABSTRACT

An electronic device includes a communication unit, a storage unit, a display unit, and a processing unit. The communication unit receives messages. The storage unit stores the messages, a label table, and a preference table. The processing unit reads the messages, parses data structure of the messages to obtain content type label of the messages in the message, identifies the content type according to the label table, determines whether there is a desired message according to the preference table and displays the message if the message is a desired message. A communication management method is also provided.

### BACKGROUND

1. Technical Field

The present disclosure relates to electronic devices and, particularly, to an electronic device and a communication management method of the electronic device.

2. Description of the Related Art

Mobile phones provide convenience to users for receiving or transmitting messages with others. However, most communication devices are targeted by business groups to deliver their advertisements. Users can be overwhelmed, or at least bored, with a great number of advertisements but can do nothing with them for the lack of a tool in the electronic device to help them to automatically filter the advertisements according to their preference.

### BRIEF DESCRIPTION OF THE DRAWINGS

The components of the drawings are not necessarily drawn to scale, the emphasis instead being placed upon clearly illustrating the principles of an electronic reader with an electronic device and a communication management method thereof. In the drawings, like reference numerals designate corresponding parts throughout multiple views.

FIG. 1 is an interface schematic view of an electronic device in accordance with an exemplary embodiment.

FIG. 2 is a block diagram of the electronic device of FIG. 1.

FIG. 3 is a flowchart of a communication management method applied in the electronic device of FIG. 1 in accordance with an exemplary embodiment.

### DETAILED DESCRIPTION

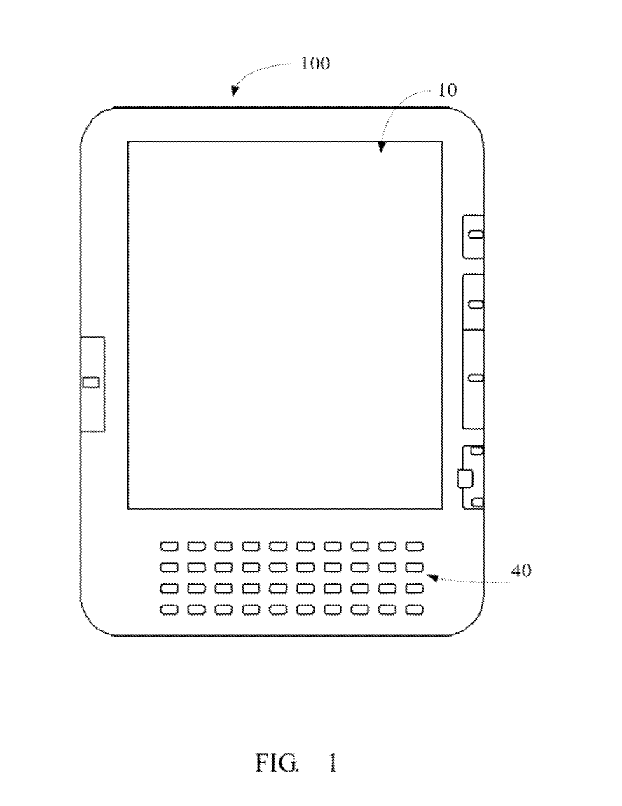

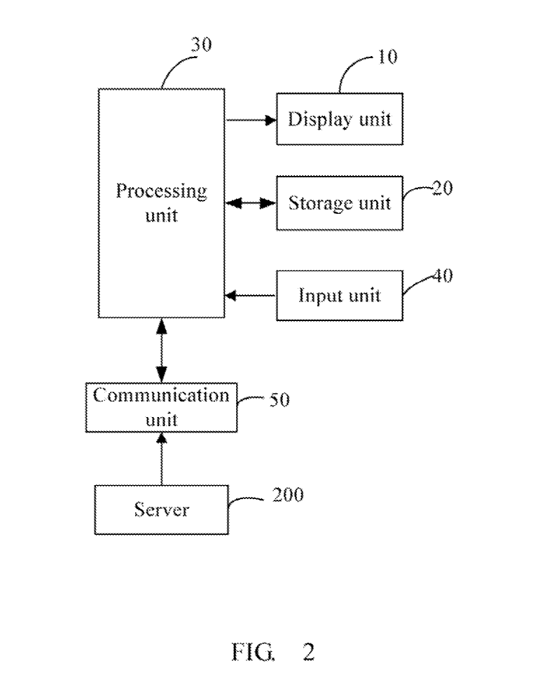

Referring to FIGS. 1 and 2, an electronic device 100 includes a display unit 10, a storage unit 20, a processing unit 30. an input unit 40 and a communication unit 50. The communication unit 50 receives messages (e.g., as short messages under short message service (SMS) and multimedia messages under multimedia message service (MMS)) from a server 200; the processing unit 30 stores the messages to the storage unit 20. In the embodiment, the message is stored in a particular folder by the processing unit 30. The message can be divided into data providing different content sorts or content types of message, such as sport, amusement, science and technology. The sever 200 pre-adds a content type label for each message, in the embodiment, the content type labels are added and embedded in the data structure of the received messages, that is, a content type label which occurs at various points within the message received, which corresponds to certain portions of the data structure of the message received.

In the embodiment, the processing unit 30 reads the message in the storage unit 20, parses the data structure of the message to obtain the content type of the message, identifies the content type of the message according to a pre-stored label table, determines whether is a desired message according to a preference table pre-stored in the storage 20, and further determines whether to display a pop-up window representing the received message on the display unit 10. The label table contains a mapping relationship between the content types of the messages and content type labels. The preference table is customizable by a user to and contains the content type labels associated with the desired message.

After the electronic device 100 receives message from the server 200, the processing unit 30 stores the message in the storage unit 20 and further parses the message. If the processing unit 30 determines that the message has a content type label included in the preference table, controls the display unit 10 to automatically display the pop-up window representing the message. If the processing unit determines that the content type label of the message is not included in the preference table, display an input interface for allowing users to customize the preference table by utilizing the input unit 40. In the embodiment, if the processing unit 30 determines the message is not a desired message according to the preference table, the processing unit 30 displays the message and a dialog box together for users, the dialog box ask the users to customize this content type of message to be preferred or not preferred. If the users customize that the content type of message is to be preferred, the processing unit 30 adds a preference tag corresponding to this content type of message in the preference table, and then displays this content type of message automatically; if the users customize this content type of message as not to be preferred, the processing unit 30 does not display the message and deletes the relevant message from the storage unit 20.

In the embodiment, furthermore, the processing unit 30 times an elapsed time since no input signal is generated by the input unit 40 and controls the display unit 10 to display the pop-up window automatically if the elapsed time exceeds a predetermined time period, such as 5 minutes. In an exemplary embodiment, when there are a number of different content type of message stored in several folders of the storage unit 20, the processing unit 30 displays a plurality of pop-up windows representing the messages, in detail, displays the content of those folders one folder after another on a cyclic basis, each message is exhibited for a predetermined length of time. Those message exhibited together belong to the same sort or different sorts.

Furthermore, the processing unit 30 also provides a button associated with each desired message. Users can operate the button such as click the button once or twice to obtain further full content of the desired message. In the embodiment, when the button mapped to a particular message is operated, the processing unit 30 firstly searches the storage 20 to obtain detailed content of the message and displays the details to the users; if there is no further details of the message in the storage 20, the processing unit 30 reads an ID number of the electronic device 200 which has been registered in the server 200 or a pre-stored e-mail address in the storage 20, and transmits the ID number or the e-mail address to the server 200 to request a download of the required details of the message. After the server 200 receives the request of the electronic device 100, the server 200 transmits the details directly to the electronic device 100 or to the e-mail box of the e-mail address.

In the embodiment, the processing unit 30 can display the message on the display unit 10, even when the electronic device 100 is in a standby or a screensaver state, as long as the processing unit 30 has determined that the elapsed time since no input signal is generated by the input unit 40 has exceeded the predetermined time period. In another embodiment, instead of timing an elapsed time since no input signal from the input unit 40 and displaying the message when the elapsed time exceeds the predetermined time period, the processing unit 30 detects a current state of the electronic device 100 and displays the message as the electronic device 100 is on the point of entering a standby or a screensaver state.

In the another embodiment, the input unit 40 includes a number of buttons with different functions, the processing unit 30 controls the electronic device 100 to exit the standby or screensaver state and the message interface in response to an operation on a particular button or particular buttons. When the electronic device 100 is in a standby or a screensaver state, the user operating other buttons except a particular button or particular buttons or clicks the interface of the standby or screensaver, the electronic device 100 does not proceed to exit from the standby or screensaver state. If the users click a button mapped to a displayed message, the full content or details of the message can be obtained or downloaded from a website by clicking that button. In the embodiment, the button mapped to displayed message can be an actual physical button or a virtual button such as a button displayed on the display unit 10.

The processing unit 30 establishes a relationship of the full content of the message with the message. There are many ways for the processing unit 30 to establish the relationship, for example, the processing unit 30 can name the full content associated with the corresponding message.

Users can enter a particular folder to open and preview the message by clicking icons of the message. Furthermore, when a folder for a particular content type of message is opened, a user can click the button mapped to this message to display further full content of the message if the details are already stored in the electronic device 100, or can download further full content of the message from a website.

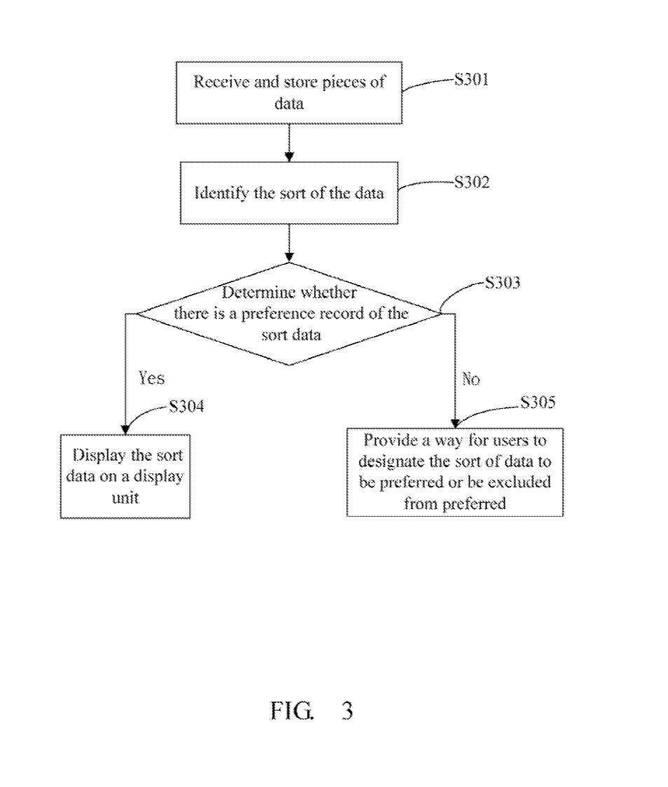

Referring to FIG. 3, a flowchart of a communication management method applied in an electronic device in accordance with an exemplary embodiment is as follows.

In step S301, the communication unit 50 receives message (e.g., short messages under short message service and multimedia messages under multimedia message service) from a sever 200, a processing unit 30 stores the message to the storage unit 20. The message can be divided into data providing different content sorts or content types of message, such as sport, amusement, science and technology. The sever 200 pre-adds a content type label for each message, in the embodiment, the content type labels are added and embedded in the data structure of the received messages, that is, a content type label which occurs at various points within the message received, which corresponds to certain portions of the data structure of the message received.

In step S302, the processing unit 30 reads the message, parses the data structure of the message to obtain the content type label of the message, identifies the type of the message according to a pre-stored label table. The label table contains a mapping relationship between the content types of the messages and content type labels.

In step S303, the processing unit 30 determines whether the received message is a desired message according to a preference table pre-stored in the storage 20. The preference table is customizable by a user to and includes the content type labels associated with the desired messages.

In step S304, the processing unit 30 displays a pop-up window representing the received message on the display unit 10 if the received message is a desired message according to the preference table.

In step S305, the processing unit 30 determines the message is not a desired message according to the preference table, the processing unit controls the display unit 10 to display an input interface for allowing users to customize the preference table. In the embodiment, If the processing unit 30 determines that the message has a content type label included in the preference table, controls the display unit 10 to automatically display the pop-up window representing the message. If the processing unit determines that the content type label of the message is not included in the preference table, display an input interface for allowing users to customize the preference table by utilizing the input unit 40. In the embodiment, if the processing unit 30 determines the message is not a desired message according to the preference table, the processing unit 30 displays the message and a dialog box together for users, the dialog box ask the users to customize this content type of message to be preferred or not preferred. If the users customize that the content type of message is to be preferred, the processing unit 30 adds a preference tag corresponding to this content type of message in the preference table, and then displays this content type of message automatically; if the users customize this content type of message as not to be preferred, the processing unit 30 does not display the message and deletes the relevant message from the storage unit 20.

Although the present disclosure has been specifically described on the basis of an exemplary embodiment thereof, the disclosure is not to be construed as being limited thereto. Various changes or modifications may be made to the embodiment without departing from the scope and spirit of the disclosure.

What is claimed is:

1. An electronic device, comprising:
a display unit;
a communication unit configured for receiving messages each having a content type label;
a storage unit configured for storing the messages, a label table and a preference table; the label table containing the mapping relationship between the content types of the messages and content type labels; the preference table being customizable by a user to include the content type labels associated with the desired messages;
a processing unit configured for:
determining a content type of received message according to the label table; and
determining whether the newly received message is a desired message according to the preference table; and
displaying a pop-up window representing the newly received message on the display unit if the newly received message is the desired message.

2. The electronic device as claimed in claim 1, wherein the processing unit is further configured for controlling the display unit to display an input interface for allowing users to customize the preference table.

3. The electronic device as claimed in claim 2, wherein the processing unit is configured for controlling the display unit to automatically display the pop-up window representing the message if the message has a content type label included in the preference table, and the processing unit is configured for deleting the message from the storage unit if the content type label of the message is not included in the preference table.

4. The electronic device as described in claim 1, further comprising an input unit for generating an input signal in response to a user's input, wherein the processing unit is configured for timing an elapsed time since no input signal is generated and controlling the display unit to display the pop-up window automatically if the elapsed time exceeds a predetermined time period.

5. The electronic device as described in claim 1, wherein the processing unit is configured for controlling the display unit to display the pop-up window automatically when the electronic device is in a standby state or a screensaver state.

6. The electronic device as described in claim 4, wherein the input unit comprises a button, the processing unit is configured for controlling the electronic device to exit the standby state or the screensaver state in response to an operation on the button.

7. The electronic device as described in claim 1, wherein if there are a number of messages stored in the storage unit, the display unit displays a plurality of pop-up windows representing the messages.

8. The electronic device as described in claim 1, wherein the display unit is configured to display a full content of the message if the pop-up window associated therewith is clicked by the user.

9. A communication management method of an electronic device comprising:
receiving a message from a server, the message having a content type label;
determining a content type of each received message according to a label table, the label table containing the mapping relationship between the content types of messages and content type labels;
determining whether the received message is a desired message according to a preference table, the preference table being customizable by a user to include the content type labels associated with the desired messages; and
displaying a pop-up window representing the received message on a display unit if the received message is the desired message.

10. The method as described in claim 9, further comprising:
controlling the display unit to display an input interface for allowing users to customize the preference table.

11. The method as described in claim 10, further comprising:
controlling the display unit to automatically display the pop-up window representing the message if the message has a content type label included in the preference table, and the processing unit is configured for deleting the message from the storage unit if the content type label of the message is not included in the preference table.

12. The method as described in claim 9, further comprising:
timing an elapsed time since no input signal is generated by an input unit and controlling the display unit to display the pop-up window automatically if the elapsed time exceeds a predetermined time period.

13. The method as described in claim 9, further comprising:
controlling the display unit to display the pop-up window automatically if the received message is the desired message when the electronic device is in a standby state or a screensaver state.

14. The method as described in claim 9, further comprising:
controlling the electronic device to exit the standby state or the screensaver state in response to an operation on a button.

15. The method as described in claim 9, further comprising:
if there are a number of messages stored in a storage unit, the display unit displays a plurality of pop-up windows representing the messages.

16. The method as described in claim 9, further comprising:
displaying a full content of the message if the pop-up window associated therewith is clicked by the user.
